(19) United States
(12) Patent Application Publication
(10) Pub. No.: US 2019/0207986 A1
(43) Pub. Date: Jul. 4, 2019

(54) METHOD AND APPARATUS FOR IDENTIFYING INDIVIDUALS WHO FREQUENTLY CHANGE THEIR MOBILE DEVICE

(71) Applicant: MOTOROLA SOLUTIONS, INC, CHICAGO, IL (US)

(72) Inventors: ROBERT MROWIEC, LISZKI (PL); GRZEGORZ ENGLOT, KRAKOW (PL); MARIUSZ R WAWROWSKI, WAWRZENCZYCE (PL); GRZEGORZ HENRYK BARTKOWIAK, KRAKOW (PL)

(21) Appl. No.: 16/306,956

(22) PCT Filed: Sep. 22, 2016
(86) PCT No.: PCT/PL2016/050043

§ 371 Date: Dec. 4, 2018

(51) Int. Cl. H04L 29/06; H04W 12/00; G06K 9/00

(52) U.S. Cl. CPC H04L 63/302; H04L 63/304; H04W 88/02; G06K 9/00288; H04W 12/007

(57) ABSTRACT

A method and apparatus are provided for identifying individuals who frequently change their mobile device. During operation, a server continuously receives facial recognition data for individuals along with device IDs detected at the time the facial recognition data was obtained. Devices associated with the individual are determined. This process is repeated and a determination is made as to whether the devices associated with the individual have changed. An individual that frequently changes devices will be identified as suspicious.

### FIELD OF THE INVENTION

The present invention generally relates to identifying potential criminals by identifying individuals who frequently change their mobile device.

### BACKGROUND OF THE INVENTION

In order to thwart law enforcements efforts to identify them, oftentimes criminals will change their mobile device (e.g., mobile phone) very frequently so they cannot be tracked and/or identified. Therefore, a need exists for techniques for quickly identifying potential criminals by identifying individuals who frequently change their mobile device.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates correlated device identities.

FIG. 2 is block diagram illustrating a general operational environment, according to one embodiment of the present invention.

FIG. 3 illustrates data provided from a network to a server.

FIG. 4 is a block diagram of a server shown in FIG. 2.

FIG. 5 is a flow chart showing the operation of the server of FIG. 4.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus are provided for identifying individuals who frequently change their mobile device. During operation, a server continuously receives facial recognition data for individuals along with device IDs detected at the time the facial recognition data was obtained. Devices associated with the individual are determined. This process is repeated and a determination is made as to whether the devices associated with the individual have changed. An individual that frequently changes devices will be identified as suspicious.

In practice, the number of devices in a vicinity of a person may be large. For example, a person may be walking through a train station with hundreds of other people. When a person's image is captured, there may be dozens of devices in the person's vicinity.

In order to determine those devices actually associated with the person, multiple detections of same person at different times are used. More particularly, each time the person is detected through facial recognition a list of detected devices is obtained. This process is repeated at later times, and common devices are identified as belonging to the person. For example, a person may be detected entering a train station and a first list of devices obtained. The person may be detected again when exiting the train station and a second list of devices are obtained. Similar devices common to both the first and the second list are then identified as being associated with the person.

Devices are “detected” by determining information such as, but not limited to a media access (MAC) address, a cellular device identifier such as, but not limited to a International Mobile Subscriber Identity (IMSI) or Temporary Mobile Subscriber Identity (TMSI), International Mobile Equipment Identifier (IMEI), Radio Identifier, Group Identifier, application IDs, such as telephone number, email address, social media ID and the like.

As an example of the above, assume that Person A has been detected at 5th and State Streets on Jun. 25, 2016 at 10:05 AM. A server may be accessed and provided the date, time, location, and image data for Person A, along with detected devices.

As is evident, the number of detected devices may be large. For example, if Person A was detected within a large city, there may be dozens of devices detected near Person A. In order to determine the devices actually associated with Person A, the above process could be repeated at another place/time. For example, assume that a Person A was again detected on Jun. 25, 2016 at 10:15 AM. The devices associated with Person A will be those devices common among both detections of Person A.

Elaborating on the above, a facial recognition system and device ID sniffer (sometimes referred to as a stingray) may be implemented, for example, at the entrances and exits to various locations. People and devices can be “identified” when they enter and leave a location. This will allow multiple detections of each individual, aiding in determining those devices associated with the individuals. It should be noted that “identifying” a device or individual does not necessarily comprise determining a name of the person. The person may simply be cataloged as an alpha-numeric entry (e.g., Person A), and later identified if needed. More particularly, if it is determined that the person has changed their device frequently, attempts may later be made to identify the name of Person A.

A determination that a user changes their device frequently can be made in any number of ways. For example, a person who changes their device more than N times in M days can be identified as a person who frequently changes their device (N and M may be variables that can be input by a user). A person may also be identified as changing their device frequently if they keep an identified device for shorter than a predetermined threshold (e.g., 1 week).

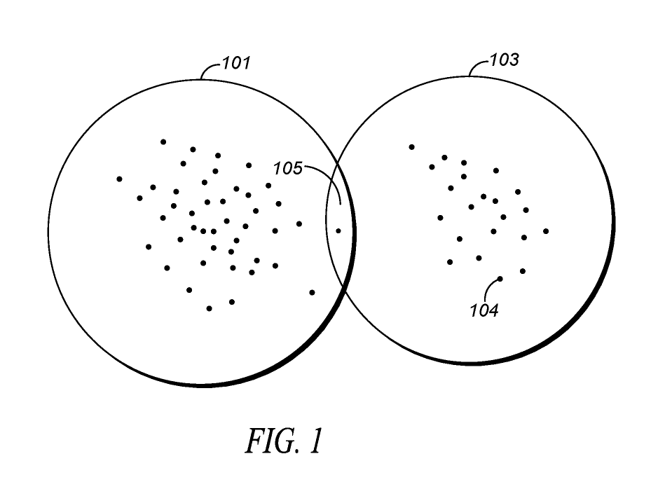

FIG. 1 illustrates the identification of suspect devices as described above. Assume that data set 101 comprise devices 104 detected when person A was identified, and that dataset 103 comprises devices 104 detected when person A was again identified. As discussed above, these devices were determined because they were associated with, or detected by a stingray near where Person A was identified via facial recognition. (Only one device 104 is labeled in FIG. 1). For example, assume that set 101 contains devices identified near an entrance to a train station when person A was identified via facial recognition and assume that set 103 contains devices identified near an exit to the train station when person A was again identified. The intersection 105 of sets 101 and 103 contains a subset devices 104 that were detected by the stingray both times person A was identified. As is evident, the intersection 105 contains many fewer devices 104 than each set alone, and may be considered those devices associated with Person A.

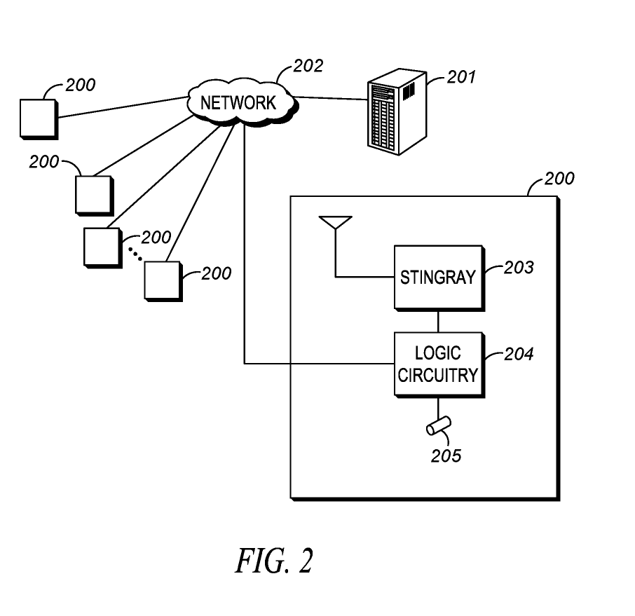

FIG. 2 is block diagram illustrating a general operating environment for associating devices with individuals as described above. As shown, multiple apparatuses 200 exist that are designed to capture facial data and nearby device identifications. Each apparatus 200 comprises sniffer 203, sometimes referred to as a “stingray” 203. These devices, technically called IMSI catchers, sniff out the identities, metadata, and/or content from devices (e.g., cell phones) within a given geographic area. Device 200 captures the cell phone identities of everyone walking past them on the street, everyone in a neighborhood, and presumably also devices carried by a target of camera 205.

Camera 205 preferably comprises an image or video sensor to capture images or video, while logic circuitry 204 comprises Logic circuitry 204 comprises a digital signal processor (DSP), general purpose microprocessor, a programmable logic device, or application specific integrated circuit (ASIC) and is utilized to accesses and control camera 205 and stingray 203.

Network 202 comprises one of any number of over-the-air or wired networks, and may be distinctly different networks in terms of technology employed and network operators used. For example a first network may comprise a private 802.11 network set up by a building operator, while a second network may be a next-generation cellular communications network operated by a cellular service provider. Thus, network 202 may comprise a next-generation cellular communication system employing a 3GPP Long Term Evolution technology (LTE) system protocol, while network 205 may comprise an 802.11 communication system protocol.

Server 201 maintains a table (database) of device IDs, images of individuals, and Dates/Times of acquisition. Server 201 is configured to store the appropriate data and determine (as described above) devices associated with individuals. Server 201 is also configured to determine if a particular individual changes devices frequently (i.e., changing devices a given number of times within a given time period, e.g., changing devices 3 times within a month).

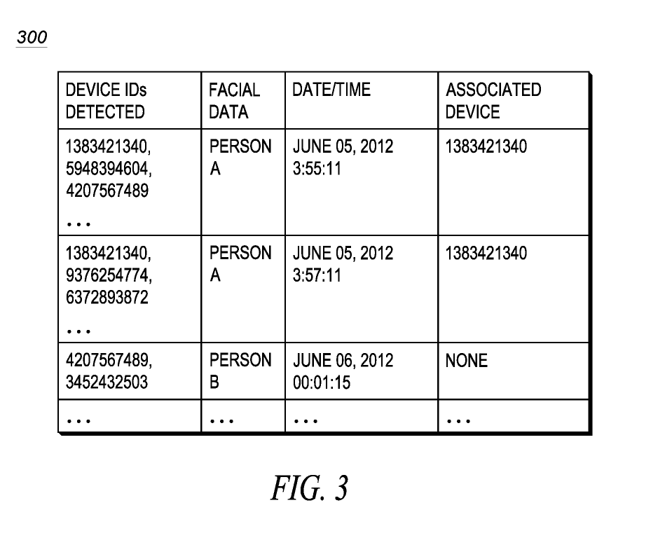

FIG. 3 illustrates data provided from device 200 to a server 201. As shown, server 201 maintains a table (database) of detected device IDs, facial data, times of acquisition of device IDs and the device(s) associated with the person “identified” by the facial data. As discussed above, device ID's may comprise a media access 802.11x (MAC) address, a cellular device identifier such as, but not limited to a International Mobile Subscriber Identity (IMSI) or Temporary Mobile Subscriber Identity (TMSI), International Mobile Equipment Identifier (IMEI), Radio Identifier, Group Identifier, application IDs, such as telephone number, email address, social media ID and the like. Facial data may simply comprise a alphanumeric number of an identified person (e.g., Person A, Person 124B, Person K230S, . . . , etc.). In alternate embodiments of the present invention Facial data may also comprise an image, or image data of the individual detected. Finally, a device(s) associated with the facial data is maintained as described above.

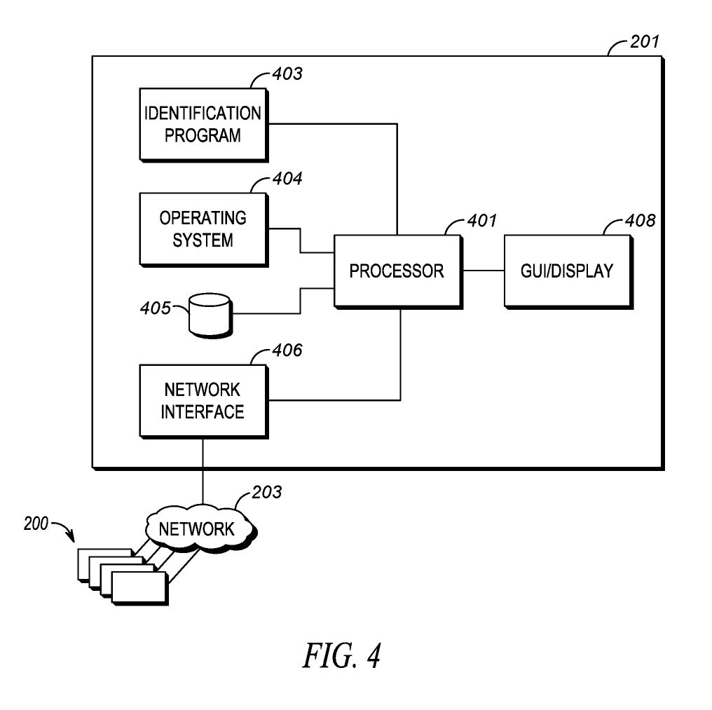

FIG. 4 is a block diagram of a server 201 shown in FIG. 2. In general, as used herein, the central server 201 being “configured” or “adapted” means that server 201 is implemented using one or more components (such as memory components, network interfaces, and central processing units) that are operatively coupled, and which, when programmed, form the means for these system elements to implement their desired functionality, for example, as illustrated by reference to the methods shown below. Central server 201 comprises a processor 401 that is communicatively coupled with various system components, including network 202, a network interface 406, a storage component 405 storing database 300 shown in FIG. 3, and graphical-user interface 408.

In the current implementation, central server 201 is configured to identify devices associated with an individual and determine if the identified devices change frequently. Central server 201 further comprises an operating system 404 and a device identification program 403 that comprises instructions (program/code) to identify devices associated with an individual and determine if the identified devices change frequently. Only a limited number of system elements are shown for ease of illustration; but additional elements may be included in the central server 201.

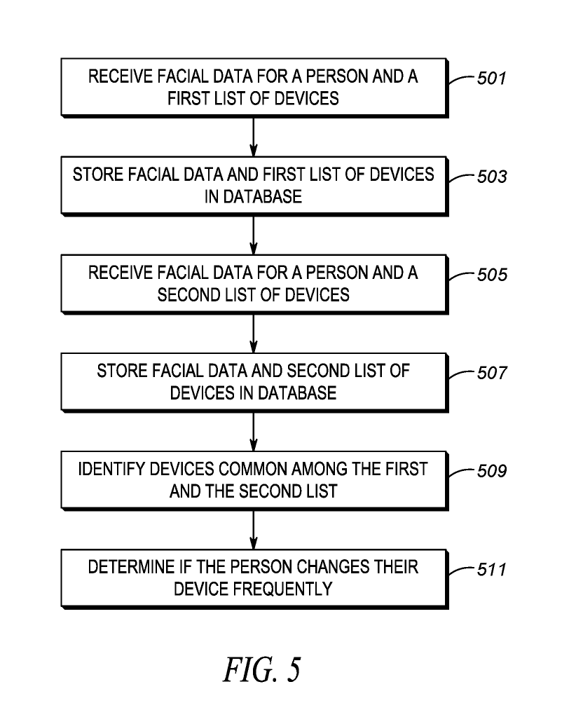

Processor 401 may be partially implemented in hardware and, thereby, programmed with software or firmware logic or code (e.g., the device identification program 403) for performing functionality described in FIG. 5; and/or the processor 401 may be completely implemented in hardware, for example, as a state machine or ASIC (application specific integrated circuit). Storage and component 405 can include short-term and/or long-term storage of various information needed for the functioning of the respective elements.

In the illustrative embodiment, network 202 is attached (i.e., connected) to the central server 201 through network interface 406 and communicates with the processor 401. Central server 201 may receive, and store data from network 202 as shown in FIG. 3.

Where network 202 is connected wirelessly to the network interface 406, network interface 406 includes elements including processing, modulating, and transceiver elements that are operable in accordance with any one or more standard or proprietary wireless interfaces, wherein some of the functionality of the processing, modulating, and transceiver elements may be performed by means of the processor 401. Examples of network interfaces (wired or wireless) include Ethernet, T1, USB interfaces, IEEE 802.11b, IEEE 802.11g, cellular network interfaces, etc.

Device identification program 403 runs on top of the operating system 404 (e.g., Windows or Linux). When the device identification program 403 is requested by the operating system 404 to be launched, it is executed therein by the processor 401. The processor 401 uses the device identification program 403 to access database 405 and identify devices associated with an individual, and determine whether or not the devices change frequently (e.g., more than once a month). It should be noted that when a device is identified as belonging to a particular individual, program 403 will update the database accordingly.

During operation of server 201, the information on detected devices, facial data, times, is received from devices 200 and stored in database 405. Associated devices and their frequency of change are determined by processor 401 running program 403. Graphical user interface (GUI 408) (which may simply comprise a keyboard and monitor) displays an output that provides information to the user. Thus, information on an individual who changes devices frequently (e.g., their image, identity, or other information) may be provided to a user of server 201 via GUI 408 as a list of device IDs. GUI 408 can also be utilized to receive a time period (e.g., 1 month, 1 day, 1 week, . . . , etc.), and then server 201 can use this time period to determine those individuals who change their devices within this time period. For example, if given a “1 week” time period, server 201 can determine those individuals who used their mobile devices for less than a week before being identified as having a new mobile device.

It should be noted that as the database contains information from long periods of times, a tally on how many times a person changed their mobile device within a time period can be obtained. So, for example, if a user input “1 week” as the time period, server 201 can use this time period and the database to determine how many times each person within the database changed their device within a week. As an example, GUI can output a list of individuals who used devices for less than a week, and then output how many times this happened.

Thus, during operation, network interface 406 continuously receives data from network 202. Processor 401 receives the network data and stores the network data as table 300 in database 405. Processor 401 will then receive (via GUI 408) instructions to identify users who frequently change their device. Processor 401 may also receive other parameters such as, but not limited a time threshold (e.g., 1 month).

Alternatively, processor 401 may receive a time period and a threshold number, and access database 405 to determine those individuals who changed their mobile devices more than the threshold number within the time period. So for example, processor 401 may receive “1 year” as the time period, and 15 as the threshold number. Processor 401 can then provide a list of all individuals who changed their mobile device more than 15 times within a year.

As is evident, the apparatus shown in FIG. 4 comprises network interface (406) receiving facial data on a person and receiving a first list of devices detected when the facial data was obtained. Database 405 is provided storing the first list of devices in a database. The network interface again receives facial data on the person and receives a second list of devices detected when the facial data was obtained, and the database again stores the second list of devices in the database. Logic circuitry (processor 401) is provided for identifying a device common among the first and the second list of devices and using past identified common devices associated with the person to determine if the person changes their mobile device with the frequency greater than the threshold.

As discussed above, GUI 408 may be provided to receive the threshold. Additionally, the facial data may comprise actual data on a face, or an image of a face. Finally, the first and the second list of devices comprises a first list of device identifications (IDs) acquired via an over-the-air sniffer.

FIG. 5 is a flow chart showing operation of the server of FIG. 4. The logic flow begins at step 501 facial data on a person is received at network interface 406. A first list of devices detected when the facial data was obtained is also received at this time. Logic circuitry 401 receives this information and stores it in database 405 (step 503). More particularly, the facial data may be stored, or an identification associated with the facial data may be stored. Also stored is the first list of devices in a database.

At step 505 facial data on the person is again received via the network interface along with a second list of devices detected when the facial data was obtained. This information is again stored by processor 401 in database 405 (step 507). Logic circuitry 401 identifies a device common among the first and the second list of devices (step 509). As discussed above, database 405 may be updated with information on the common device.

Finally at step 511 logic circuitry 401 uses past identified common devices associated with the person to determine if the person changes their mobile device with the frequency greater than the threshold. As discussed above, the threshold may be obtained via GUI 408, while facial data may comprise an image of a face. Finally, the step of receiving the first list and second list of devices may comprise the step of receiving a first and second list of device identifications (IDs) acquired via an over-the-air sniffer (stingray 203).

In the foregoing specification, specific embodiments have been described. However, one of ordinary skill in the art appreciates that various modifications and changes can be made without departing from the scope of the invention as set forth in the claims below. For example, the above description was provided to enable the determination of individuals through the detection of their device IDs. The device IDs were provided by network infrastructure. However, in alternate embodiments of the present invention these device IDs may be provided to a central server via any method. For example, a child registration database may associate a particular device with a child. These devices may communicate directly with a central server. Alternatively, in an LTE system using “ProSe”. one wireless device can discover other wireless devices in range. Wireless nodes capturing IDs in range can then relay this information to a server. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for determining whether an individual changes their mobile device with a frequency greater than a threshold, the method comprises the step of:
receiving facial data on a person;
receiving a first list of devices detected when the facial data was obtained;
storing the first list of devices in a database;
again receiving facial data on the person;
receiving a second list of devices detected when the facial data was obtained;
storing the second list of devices in the database;
identifying a device common among the first and the second list of devices; and
using past identified common devices associated with the person to determine if the person changes their mobile device with the frequency greater than the threshold.

2. The method of claim 1 further comprising the step of:
receiving the threshold via a graphical user interface (GUI).

3. The method of claim 2 wherein the step of receiving facial data comprises the step of receiving an image of a face.

4. The method of claim 3 wherein the step of receiving the first list of devices comprises the step of receiving a first list of device identifications (IDs) acquired via an over-the-air sniffer.

5. The method of claim 4 wherein the first list of device IDs comprise a list of media access (MAC) address, cellular device identifier, a International Mobile Subscriber Identity (IMSI), a Temporary Mobile Subscriber Identity (TMSI), an International Mobile Equipment Identifier (IMEI), a Radio Identifier, Group Identifier, an application IDs, a telephone number, an email address, and/or a social media ID.

6. A method for determining whether an individual changes their mobile device with a frequency greater than a threshold, the method comprises the step of:
receiving the threshold via a graphical user interface (GUI);
receiving an image of a person's face;
receiving a first list of devices detected via an over-the-air sniffer when the image of the face was obtained;
storing the first list of devices in a database;
again receiving an image of the face;
receiving a second list of devices detected by a second over-the-air sniffer when the image of the face was obtained;
storing the second list of devices in the database;
identifying a device common among the first and the second list of devices; and
using past identified common devices associated with the person to determine if the person changes their mobile device with the frequency greater than the threshold.

7. The method of claim 6 wherein the first list of device IDs comprise a list of media access (MAC) address, cellular device identifier, a International Mobile Subscriber Identity (IMSI), a Temporary Mobile Subscriber Identity (TMSI), an International Mobile Equipment Identifier (IMEI), a Radio Identifier, Group Identifier, an application IDs, a telephone number, an email address, and/or a social media ID.

8. An apparatus comprising:
a network interface receiving facial data on a person and receiving a first list of devices detected when the facial data was obtained;
a database storing the first list of devices;
the network interface again receiving facial data on the person and receiving a second list of devices detected when the facial data was obtained;
the database storing the second list of devices in the database; and
logic circuitry identifying a device common among the first and the second list of devices and using past identified common devices associated with the person to determine if the person changes their mobile device with a frequency greater than a threshold.

9. The apparatus of claim 8 further comprising:
a graphical user interface (GUI) receiving the threshold.

10. The apparatus of claim 9 wherein the facial data comprises an image of a face.

11. The apparatus of claim 10 wherein the first list of devices comprises a first list of device identifications (IDs) acquired via an over-the-air sniffer.

12. The apparatus of claim 11 wherein the first list of device IDs comprise a list of media access (MAC) address, cellular device identifier, a International Mobile Subscriber Identity (IMSI), a Temporary Mobile Subscriber Identity (TMSI), an International Mobile Equipment Identifier (IMEI), a Radio Identifier, Group Identifier, an application IDs, a telephone number, an email address, and/or a social media ID.
